(19) United States
(12) Patent Application Publication
(10) Pub. No.: US 2022/0389246 A1
(43) Pub. Date: Dec. 8, 2022

(54) RADIATION CURABLE INKJET INK, DECORATIVE SHEET, AND METHOD OF PRODUCING DECORATIVE SHEET

(71) Applicant: 3M INNOVATIVE PROPERTIES COMPANY, St. Paul, MN (US)

(72) Inventors: Katsuya Ono, Yamagata (JP); Naota Sugiyama, Kanagawa (JP); Yoshihiro Kashihara, Kanagawa (JP); Koji Saito, Yamagata (JP); Bruce A. Nerad, Oakdale, MN (US); Thomas A. Speckhard, Oakdale, MN (US)

(21) Appl. No.: 17/772,565

(22) PCT Filed: Nov. 17, 2020
(86) PCT No.: PCT/IB2020/060825

§ 371 Date: Apr. 28, 2022

(30) Foreign Application Priority Data
Nov. 19, 2019 (JP) 2019-208716

(51) Int. Cl. C09D 11/101; C09D 11/38; B41M 7/00

(52) U.S. Cl. CPC C09D 11/101; C09D 11/38; B41M 7/0081

(57) ABSTRACT

A radiation curable inkjet ink which has good surface curability even in air, and is capable of providing a cured product having low odor, good flexibility, and low-temperature impact resistance is described. In particular, radiation curable inkjet ink including from 20 to 40 parts by mass of a bifunctional urethane (meth)acrylate oligomer and from 50 to 80 parts by mass of a monofunctional monomer, based on 100 parts by mass of polymerizable components and an α-hydroxyketone oligomer and a benzophenone compound as photoinitiators are described.

### TECHNICAL FIELD

The present disclosure relates to a radiation curable inkjet ink, a decorative sheet, and a method of producing the decorative sheet.

### BACKGROUND ART

A decorative sheet is used to decorate inner and exterior walls of buildings. In recent years, architecture and construction industries increasingly demand interior finishes that can exhibit the real feel of a material and provide a unique design. In order to achieve such real feel of a material with the decorative sheet, it is necessary to form a surface with a height variation (asperity) on the decorative sheet. By performing color printing and surface texture (2.5D surface) formation using a UV curable inkjet ink, it is possible to impart the decorative sheet a surface texture that exhibits the real feel of a material and a unique design. Inkjet printing is advantageous in reducing lead time and small-lot production.

Patent Document 1 (US 2010/0,285,282 A) discloses a radiation curable inkjet ink containing at least 50 wt. % of cyclic trimethylolpropane formal acrylate (CTFA), further contains a free radical photoinitiator, and contains little volatile compound.

Patent Document 2 (JP 2012-162615 A) discloses “an inkjet ink composition containing a polymerizable monomer polymerizable by active energy rays, and a photopolymerization initiator, wherein the polymerizable monomer contains from 0.5 mass % to 13 mass % of a polymerizable phosphate ester compound having a phosphate ester group and an ethylenic double bond group in a molecule, and from 10 mass % to 75 mass % of a monofunctional monomer having one ethylenic double bond group and having no phosphate group in the molecule, in all monomers, and the photopolymerization initiator includes an acyl phosphine oxide-based initiator and an α-hydroxyketone-based initiator in which the number of phenyl groups in the skeleton is 1 or less, and has a viscosity from 3 to 50 mPa·s at 25° C.”.

Patent Document 3 (JP 2007-321034A) discloses “an ultraviolet curable ink composition for inkjet recording, containing a photopolymerizable compound having an ethylenic double bond, a mixture of oxy-phenyl-acetic acid 2-[2-oxo-2-phenyl-acetoxy-ethoxy]-ethyl ester and oxy-phenyl-acetic acid 2-[2-hydroxy-ethoxy]-ethyl ester as a photopolymerization initiator, an acylphosphine oxide-based compound, and amine as a photoinitiator.

### SUMMARY OF INVENTION

### Technical Problem

Generally, a cured product of UV curable ink has an odor. From the viewpoint of health and safety in indoor applications, it is desirable to reduce the odor of the cured product as much as possible. The odor of the cured product of the UV curable ink is mainly derived from unreacted monomers, photoinitiators, and decomposition products thereof. Therefore, in general printing systems such as flexographic printing and gravure printing, the printing is performed under an inert gas atmosphere such as a nitrogen gas atmosphere in order to sufficiently advance the reaction with a smaller amount of the photoinitiator.

In order to form a 2.5D surface by inkjet printing, it is required that the ink is rapidly cured before the ink droplets wet and spread out on the substrate or ink that has already been printed and cured. On the other hand, it is difficult to perform printing using a multi-pass inkjet printer in an inert gas atmosphere. In the inkjet printing, curing is performed with a print head positioned in an inert gas atmosphere. At this time, the ink on the print head is easily cured by stray light of the ultraviolet rays used for curing, resulting in nozzle clogging.

The interior material is often installed in an environment from 10° C. to 40° C. so as to cover not only a flat surface of a structure but also a curved surface or corner of the structure. In order to prevent breakage during construction and use, the interior material is required to have good flexibility, elongation properties and low-temperature impact resistance, for example.

The present disclosure provides a radiation curable inkjet ink which has good surface curability even in air, and is capable of providing a cured product having low odor, good flexibility, and low-temperature impact resistance.

### Solution to Problem

According to an embodiment, a radiation curable inkjet ink including from 20 to 40 parts by mass of a bifunctional urethane (meth)acrylate oligomer and from 50 to 80 parts by mass of a monofunctional monomer, based on 100 parts by mass of polymerizable components; and an α-hydroxyketone oligomer and a benzophenone compound as photoinitiators is provided.

According to another embodiment, a decorative sheet having a printed layer including a cured product of the radiation curable inkjet ink is provided.

According to still another embodiment, a method of producing a decorative sheet, the method including preparing a substrate; forming a printed layer on the substrate by inkjet printing the radiation curable inkjet ink onto the substrate; and curing the printed layer by irradiating the printed layer with radiation is provided.

### Advantageous Effects of Invention

The radiation curable inkjet ink of the present disclosure is a radiation curable inkjet ink which has good surface curability even in air, and is capable of providing a cured product having low odor, good flexibility, and low-temperature impact resistance. The radiation curable inkjet ink of the present disclosure can be suitably used for producing a decorative sheet.

Note that the above descriptions should not be construed to be a disclosure of all of the embodiments and benefits of the present disclosure.

### BRIEF DESCRIPTION OF THE DRAWINGS

FIG. 1 is a schematic cross-sectional view of a decorative sheet of an embodiment.

### DESCRIPTION OF EMBODIMENTS

Hereinafter, representative embodiments of the present invention will be described in more detail for the purpose of illustration, but the present invention is not limited to these embodiments.

In the present disclosure, a “monofunctional monomer” means a compound having only one reactive functional group, and generally has a molecular weight of less than 1000.

In the present disclosure, an “oligomer” means a compound having a plurality of units derived from monomers, and typically has a molecular weight of greater than or equal to approximately 350, or greater than or equal to approximately 500. For example, an urethane (meth)acrylate oligomer is a compound including a plurality of units having an urethane bond, and having a (meth)acryloyloxy group.

In the present disclosure, a “texture” means a three-dimensional shape on a surface which can be sensed visually or tactually by an observer.

In the present disclosure, “transparent” means that the total light transmittance of a material or an article at a wavelength range of from 400 to 700 nm is greater than or equal to approximately 70%, greater than or equal to approximately 80%, or greater than or equal to approximately 90%. The total light transmittance can be determined in accordance with JIS K 7361-1:1997 (ISO 13468-1:1996).

In the present disclosure, “(meth)acrylic” means acrylic or methacrylic, “(meth)acryloyl” means acryloyl or methacryloyl, and “(meth)acrylate” means acrylate or methacrylate.

A radiation curable inkjet ink includes from 20 to 40 parts by mass of a bifunctional urethane (meth)acrylate oligomer and from 50 to 80 parts by mass of a monofunctional monomer, based on 100 parts by mass of polymerizable components; and an α-hydroxyketone oligomer and a benzophenone compound as photoinitiators. By using a photoinitiator of a specific combination and containing a specific amount of a bifunctional urethane (meth)acrylate oligomer and a monofunctional monomer as polymerizable components, it is possible to provide a radiation inkjet ink having good surface curability even in air, and a cured product having low odor, good flexibility, and low-temperature impact resistance. The radiation curable inkjet ink is a radical polymerization type acrylic ink, and the cured product thereof is excellent in transparency, strength, weather resistance, and the like, and is advantageous in a case of where, for example, a decorative sheet is used as an interior material.

The bifunctional urethane (meth)acrylate oligomer has a (meth)acryloyl group introduced in both terminals of a urethane oligomer which is a reaction product of a diol and a diisocyanate. The (meth)acryloyl group reacts with a (meth)acryloyl group of another bifunctional urethane (meth)acrylate oligomer or a monofunctional monomer to form a cured product. The bifunctional urethane (meth)acrylate oligomer can impart flexibility and low-temperature impact resistance to the cured product of the radiation curable inkjet ink, and has a relatively high molecular weight contributing to the improvement of the surface curability in air. The bifunctional urethane (meth)acrylate oligomer may be one type or a combination of two or more types. All the diol and the diisocyanate constituting the urethane oligomer can be one type or a combination of two or more types.

Examples of the diol include polyether polyol, polyether polyol, polycarbonate polyol, and polycaprolactone polyol.

The diol may include a low molecular weight diol. Examples of the low molecular weight diol include ethylene glycol, diethylene glycol, propylene glycol, dipropylene glycol, 1,3-butanediol, 1,4-butanediol, 2-methyl-1,3-propanediol, 1,5-pentanediol, 1,6-hexanediol, neopentyl glycol, 1,4-cyclohexanedimethanol, bisphenol A, bisphenol F, hydrogenated bisphenol A, hydrogenated bisphenol F, 1,2-cyclopentanediol, and tricyclo[5.2.1.0^{2,6}]decanedimethanol.

Examples of diisocyanate include aliphatic isocyanate and aromatic isocyanate. Examples of the aliphatic diisocyanate include tetramethylene diisocyanate, hexamethylene diisocyanate, 2,4,4-trimethylhexamethylene diisocyanate, 2,2,4-trimethylhexamethylene diisocyanate, decamethylene diisocyanate, 1,3-cyclohexane diisocyanate, 1,4-cyclohexane diisocyanate, isophorone diisocyanate, and 4,4′-methylene bis(cyclohexyl isocyanate). Examples of the aromatic isocyanate include 2,4-toluene diisocyanate, 2,6-toluene diisocyanate, methylenediphenyl 4,4′-diisocyanate, 1,3-phenylene diisocyanate, 1,4-phenylene diisocyanate, 3,3′-dimethyldiphenylmethane-4,4′-diisocyanate, diphenylmethane-2,2′-diisocyanate, diphenylmethane-2,4′-diisocyanate, 4,4′-diisocyanato-3,3′-dimethylbiphenyl, 1,5-naphthalene diisocyanate, and 2-methyl-1,5-naphthalene diisocyanate.

When both the diol and the diisocyanate are an aliphatic compound, the weather resistance of the cured product of the radiation curable inkjet ink and the printed layer containing the cured product can be enhanced.

The (meth)acryloyl group can be introduced by a reaction of a hydroxyl group-containing (meth)acrylate with an isocyanato terminal of the urethane oligomer. Examples of the hydroxyl group-containing (meth)acrylate include 2-hydroxyethyl acrylate, 2-hydroxyethyl methacrylate, 2-hydroxypropyl acrylate, 2-hydroxypropyl methacrylate, 2-hydroxybutyl acrylate, 2-hydroxybutyl methacrylate, dipropylene glycol monoacrylate, and dipropylene glycol monomethacrylate. The hydroxyl group-containing (meth)acrylate can be used alone or two or more types thereof may be used in combination. In this embodiment, it is desirable that the diisocyanate be used in an excess amount relative to the amount of the diol, that is, the molar ratio of the NCO group to the OH group be greater than 1 during synthesis of the urethane oligomer.

The (meth)acryloyl group can be introduced by a reaction of an isocyanato group-containing (meth)acrylate with a hydroxyl group terminal of the urethane oligomer. Examples of the isocyanato group-containing (meth)acrylate include 2-isocyanatoethyl acrylate and 2-isocyanatoethyl methacrylate. In this embodiment, it is desirable that the diol be used in an excess amount relative to the amount of the diisocyanate, that is, the molar ratio of the NCO group to the OH group be less than 1 during synthesis of the urethane oligomer.

Examples of the bifunctional urethane (meth)acrylate oligomer include a polyester urethane di(meth)acrylate oligomer, a polycarbonate urethane di(meth)acrylate oligomer, and a polyether urethane di(meth)acrylate oligomer.

The bifunctional urethane (meth)acrylate oligomer is preferably a bifunctional urethane acrylate oligomer from the viewpoint that the radiation curable inkjet ink is excellent in the surface curability in air.

The bifunctional urethane (meth)acrylate oligomer is advantageously a bifunctional aliphatic urethane acrylate oligomer. The bifunctional aliphatic urethane acrylate oligomer can improve the surface curability of the radiation curable inkjet ink in the air and provide a cured product excellent in the weather resistance and a protective layer containing such a cured product.

The number average molecular weight Mn of the bifunctional urethane (meth)acrylate oligomer is generally greater than or equal to approximately 500, greater than or equal to approximately 1000, or greater than or equal to approximately 1200, and less than or equal to approximately 5000, less than or equal to approximately 4000, or less than or equal to approximately 3000. The weight average molecular weight Mw of the bifunctional urethane (meth)acrylate oligomer is generally greater than or equal to approximately 500, greater than or equal to approximately 1000, or greater than or equal to approximately 1200, and less than or equal to approximately 5000, less than or equal to approximately 4000, or less than or equal to approximately 3000. The number average molecular weight Mn and the weight average molecular weight Mw are values determined by gel permeation chromatography using a polystyrene standard. The weight average molecular weight Mw of the bifunctional urethane (meth)acrylate oligomer is preferably from 500 to 5000, from the viewpoint that a cured product having the excellent low-temperature impact resistance and the elongation properties can be formed.

It is desirable that the radiation curable inkjet ink contain the bifunctional urethane (meth)acrylate oligomer in an amount of greater than or equal to approximately 20 parts by mass, or less than or equal to approximately 40 parts by mass, relative to 100 parts by mass of a polymerizable component. It is desirable that the radiation curable inkjet ink contain the bifunctional urethane (meth)acrylate oligomer in an amount of greater than or equal to approximately 22 parts by mass, greater than or equal to approximately 24 parts by mass, less than or equal to approximately 35 parts by mass, or less than or equal to approximately 30 parts by mass relative to 100 parts by mass of a polymerizable component. When the content of the bifunctional urethane (meth)acrylate oligomer relative to 100 parts by mass of the polymerizable component is greater than or equal to approximately 20 parts by mass, the flexibility and low-temperature impact resistance of the cured product of the radiation curable inkjet ink can be further enhanced, and the surface curability in air can be further improved. When the content of the bifunctional urethane (meth)acrylate oligomer relative to 100 parts by mass of the polymerizable component is less than or equal to approximately 40 parts by mass, favorable inkjet discharge properties can be obtained. In the present disclosure, the “polymerizable component” includes the bifunctional urethane (meth)acrylate oligomer, the monofunctional monomer, and other polymerizable monomers and other oligomers.

The monofunctional monomer forms the cured product together with the bifunctional urethane (meth)acrylate oligomer as a polymerizable component, and also functions as a viscosity adjusting component of the radiation curable inkjet ink. Examples of the monofunctional monomer include acrylic monofunctional monomers such as linear alkyl (meth)acrylate, branched alkyl (meth)acrylate, alicyclic (meth)acrylate, (meth)acrylate having a dioxane moiety or dioxolane moiety, phenoxyalkyl (meth)acrylate, alkoxyalkyl (meth)acrylates, cyclic monoether-containing (meth)acrylate, hydroxyl group-containing (meth)acrylate, a nitrogen-containing (meth)acryloyl compound, and (meth)acrylic acid. The monofunctional monomer may be one type or a combination of two or more types.

Examples of the linear alkyl (meth)acrylate include methyl(meth)acrylate, ethyl(meth)acrylate, n-butyl(meth)acrylate, n-hexyl(meth)acrylate, n-octyl(meth)acrylate, n-decyl(meth)acrylate and n-dodecyl(meth)acrylate.

Examples of the branched alkyl (meth)acrylate include isoamyl(meth)acrylate, 2-methylbutyl(meth)acrylate, 2-ethylhexyl(meth)acrylate, isooctyl(meth)acrylate, and isononyl(meth)acrylate.

Examples of the alicyclic (meth)acrylate include cyclohexyl(meth)acrylate, isobornyl(meth)acrylate, and 3,3,5-trimethylcyclohexyl(meth)acrylate.

Examples of the (meth)acrylate having a dioxane moiety include (5-ethyl-1,3-dioxane-5-yl) methyl (meth)acrylate (also referred to as cyclic trimethylolpropane formal acrylate), (2-methyl-5-ethyl-1,3-dioxane-5-yl) methyl (meth)acrylate, (2,2-dimethyl-5-ethyl-1,3-dioxane-5-yl) methyl (meth)acrylate, (2-methyl-2,5-diethyl-1,3-dioxane-5-yl) methyl (meth)acrylate, (2,2,5-triethyl-1,3-dioxane-5-yl) methyl (meth)acrylate, (2,5-diethyl-1,3-dioxane-5-yl) methyl (meth)acrylate, and polyethyleneglycol (meth)acrylate having 1,3-dioxane ring. Examples of the (meth)acrylate having a dioxolane moiety include (2-methyl-2-ethyl-1,3-dioxolan-4-yl)methyl(meth)acrylate, (2-cyclohexyl-1,3-dioxolan-4-yl)methyl(meth)acrylate, (2,2-dimethyl-1,3-dioxolan-4-yl)methyl(meth)acrylate, (2-methyl-2-isobutyl-1,3-dioxolan-4-yl)methyl(meth)acrylate, (2-methyl-2-acetonyl-1,3-dioxolan-4-yl)methyl(meth)acrylate, (2-oxo-1,3-dioxolan-4-yl)methyl(meth)acrylate, 2-(2-oxo-1,3-dioxolan-4-yl)ethyl(meth)acrylate, and 3-(2-oxo-1,3-dioxolan-4-yl)propyl(meth)acrylate.

Examples of the phenoxyalkyl (meth)acrylate include phenoxyethyl(meth)acrylate.

Examples of the alkoxyalkyl (meth)acrylate include methoxypropyl(meth)acrylate, 2-methoxybutyl(meth)acrylate, and 2-(2-ethoxyethoxy)ethyl(meth)acrylate.

Examples of the cyclic monoether-containing (meth)acrylate include glycidyl(meth)acrylate and tetrahydrofurfuryl(meth)acrylate.

Examples of the hydroxyl group-containing (meth)acrylate include 2-hydroxyethyl(meth)acrylate, 2-hydroxypropyl(meth)acrylate, and 4-hydroxybutyl(meth)acrylate.

Examples of the nitrogen-containing (meth)acryloyl compound include (meth)acrylamide and N,N-diethyl(meth)acrylamide.

Examples of the other monofunctional monomers include vinyl compounds such as vinylacetate, vinylpropionate, styrene, and vinyltoluene; unsaturated nitriles such as acrylonitrile and methacrylonitrile; and unsaturated carboxylic acids such as crotonic acid, itaconic acid, fumaric acid, citraconic acid, and maleic acid.

From the viewpoint that the weather resistance and low-temperature impact resistance of the cured product can be increased, the monofunctional monomer is preferably at least one type selected from the group consisting of linear or branched alkyl (meth)acrylates, alicyclic (meth)acrylates, and (meth)acrylates having a dioxane moiety or a dioxolane moiety.

The monofunctional monomer is preferably an acrylate monomer from the viewpoint that the radiation curable inkjet ink is excellent in the surface curability in air.

The radiation curable inkjet ink contains the monofunctional monomer in an amount of greater than or equal to approximately 50 parts by mass, or less than or equal to approximately 80 parts by mass, relative to 100 parts by mass of a polymerizable component. The radiation curable inkjet ink contain the monofunctional monomer in an amount of greater than or equal to approximately 55 parts by mass, greater than or equal to approximately 60 parts by mass, less than or equal to approximately 78 parts by mass, or less than or equal to approximately 75 parts by mass relative to 100 parts by mass of a polymerizable component. When the content of the monofunctional monomer relative to 100 parts by mass of the polymerizable component is greater than or equal to approximately 50 parts by mass, favorable inkjet discharge properties can be obtained. When the content of the monofunctional monomer relative to 100 parts by mass of the polymerizable component is less than or equal to approximately 80 parts by mass, the flexibility and low-temperature impact resistance of the cured product of the radiation curable inkjet ink can be further enhanced, and the surface curability in air can be further improved.

The radiation curable inkjet ink may further contain a polyfunctional (meth)acrylate monomer. The polyfunctional (meth)acrylate monomer functions as a cross-linking agent, and can improve the surface curability of the radiation curable inkjet ink in the air and increase the strength and durability of the cured product. When crosslinking is performed using the polyfunctional (meth)acrylate monomer, adhesive properties to the base film layer of the cured product or the other layers of the decorative sheet may be enhanced.

As the polyfunctional (meth)acrylate monomer, for example, a bifunctional (meth)acrylate such as 1,4-butanediol di(meth)acrylate, 1,6-hexanediol di(meth)acrylate, ethyleneglycol di(meth)acrylate, cyclohexanedimethanol di(meth)acrylate, diethyleneglycol di(meth)acrylate, dipropyleneglycol di(meth)acrylate, or polyethyleneglycol di(meth)acrylate; a trifunctional (meth)acrylate such as glycerol tri(meth)acrylate, trimethylolpropane tri(meth)acrylate, or pentaerythritol tri(meth)acrylate; or a (meth)acrylate having four or more functional groups such as ditrimethylolpropane tetra(meth)acrylate, dipentaerythritol penta(meth)acrylate, or pentaerythritol tetra(meth)acrylate can be used.

The polyfunctional (meth)acrylate monomer is preferably a polyfunctional acrylate monomer from the viewpoint that the radiation curable inkjet ink is excellent in the surface curability in air.

In one embodiment where the radiation curable inkjet ink contains the polyfunctional (meth)acrylate monomer, the radiation curable inkjet ink contains the polyfunctional (meth)acrylate monomer in an amount of greater than or equal to approximately 0.1 parts by mass, greater than or equal to approximately 1 part by mass, or greater than or equal to approximately 2 parts by mass, and less than or equal to approximately 10 parts by mass, less than or equal to approximately 8 parts by mass, or less than or equal to approximately 5 parts by mass, relative to 100 parts by mass of the polymerizable component.

The radiation curable inkjet ink may further contain other polymerizable oligomers besides the bifunctional urethane (meth)acrylate oligomer. Other polymerizable oligomers include polyester (meth)acrylate and epoxy (meth)acrylate. The polymerizable oligomer may be a monofunctional or polyfunctional oligomer.

In one embodiment where the radiation curable inkjet ink contains other polymerizable oligomers, the radiation curable inkjet ink contains the other polymerizable oligomers in an amount of greater than or equal to approximately 0.1 parts by mass, greater than or equal to approximately 1 part by mass, or greater than or equal to approximately 2 parts by mass, and less than or equal to approximately 10 parts by mass, less than or equal to approximately 8 parts by mass, or less than or equal to approximately 5 parts by mass, relative to 100 parts by mass of the polymerizable component.

The radiation curable inkjet ink contains a combination of an α-hydroxyketone oligomer and a benzophenone compound as a photoinitiator. The α-hydroxyketone oligomer is an intramolecular-cleavage-type photoinitiator, and the benzophenone compound is a hydrogen-abstraction-type photoinitiator. By combining these photoinitiators, the surface curability in the air can be improved, whereby the generation of odor derived from the unreacted monofunctional monomer can be suppressed. The α-hydroxyketone oligomer has a relatively large molecular weight, and at least one of the residues after intramolecular cleavage remains in the cured product, and thus, generation of odor derived from the photoinitiator and decomposition products thereof can be suppressed. The α-hydroxyketone oligomer and the benzophenone compound can be used alone or two or more types thereof may be used in combination.

The α-hydroxyketone oligomer is a multimer such as a dimer or trimer of a monomer containing an α-hydroxyketone moiety. Examples of the monomers containing the α-hydroxyketone moiety include derivatives in which an α-hydroxyketone compound, such as 2-hydroxy-2-methyl-1-phenylpropan-1-one, 1-hydroxycyclohexyl phenyl ketone, and 1-[4-(2-hydroxyethoxy)-phenyl]-2-hydroxy-2-methylpropanone, is substituted with a polymerizable group. Examples of the polymerizable group include a vinyl group, a 1-methylvinyl group, a (meth)acryloyloxy group, a (meth)acryloyloxyethoxy group, and a glycidyloxy group. Examples of such monomers include 2-hydroxy-2-methyl-1-[4-(1-methylvinyl) phenyl]propanone and 2-hydroxy-2-methyl-1-[4-(2-acryloyloxyethoxy) phenyl]propanone.

The number average molecular weight of the α-hydroxyketone oligomer is preferably greater than or equal to approximately 350 and less than or equal to approximately 1000. When the α-hydroxyketone oligomer has a number average molecular weight of greater than or equal to approximately 350, a cured product having a low odor can be formed. When the α-hydroxyketone oligomer has a number average molecular weight of less than or equal to approximately 1000, compatibility with the polymerizable component of the radiation curable inkjet ink can be enhanced.

The α-hydroxyketone oligomer preferably has a 2-hydroxy-2-methyl-1-oxopropyl group. The α-hydroxyketone oligomer having a 2-hydroxy-2-methyl-1-oxopropyl group is cleaved in the molecule upon irradiation by ultraviolet rays to produce acetone, and the produced acetone is volatilized due to its relatively low boiling point. Since the other residue is an oligomer constituent part, it remains in the cured product. Thus, the odor of the cured product can be suppressed effectively.

Examples of the α-hydroxyketone oligomer include oligo (2-hydroxy-2-methyl-1-[4-(1-methylvinyl) phenyl] propanone) (Esacure (trade name) ONE, IGM Resins B.M.V. (Waalwijk, Netherlands)).

It is desirable that the radiation curable inkjet ink contain the α-hydroxyketone oligomer in an amount of greater than or equal to approximately 1 part by mass, greater than or equal to approximately 2 parts by mass, less than or equal to approximately 15 parts by mass, or less than or equal to approximately 10 parts by mass relative to 100 parts by mass of a polymerizable component.

The benzophenone compound may be a compound having a substituted or unsubstituted benzophenone structure in the molecule, and may be an oligomer or a polymer.

The molecular weight of the benzophenone compound is preferably greater than or equal to approximately 182 g/mol and less than or equal to approximately 1000 g/mol. When the molecular weight of the benzophenone compound is in the range described above, the mobility of the excited benzophenone compound or benzophenone radical in the radiation curable inkjet ink can be increased, and the surface curability in air can be further improved.

Examples of the benzophenone compound include benzophenone, 4-methylbenzophenone, 2,4,6-trimethylbenzophenone, 4-methoxybenzophenone, benzoylbenzoic acid, methyl-o-benzoylbenzoate, 4-benzoyl-4′-methyldiphenyl sulfide, 4,4′-dihydroxybenzophenone, 4,4′-dichlorobenzophenone, diesters of carboxymethoxybenzophenone and polytetramethylene glycol (for example, Omnipol BP, IGM Resins B.V. (Waalwijk, Netherlands)), and polymers of benzophenone derivatives (for example, Omnipol 2702, IGM Resins B.V. (Waalwijk, Netherlands)).

In some embodiments, the radiation curable inkjet ink contains the benzophenone compound in an amount of greater than or equal to approximately 1 part by mass, or greater than or equal to approximately 2 parts by mass, and less than or equal to approximately 15 parts by mass, or less than or equal to approximately 10 parts by mass, relative to 100 parts by mass of the polymerizable component.

The radiation curable inkjet ink may contain, as an optional component, a light stabilizer, a polymerization inhibitor, an UV absorbent, a defoaming agent, an anti-smudge agent, a surface conditioner, and a filler.

It is advantageous that the radiation curable inkjet ink is a solvent-free ink from the viewpoint of environmental load, workability, and curability. An aqueous ink or a solvent-based ink can be used as the radiation curable inkjet ink.

The radiation curable inkjet ink may be transparent, semi-transparent, or opaque, and may be colorless or colored. In one embodiment, when the radiation curable inkjet ink is transparent and a cured product having a thickness of 50 p.m is formed, the total light transmittance at a wavelength range from 400 to 700 nm of the cured product is greater than or equal to approximately 70%, greater than or equal to approximately 80%, or greater than or equal to approximately 90%.

The viscosity of the radiation curable inkjet ink at 25° C. may be greater than or equal to approximately 5 mPa·s, or greater than or equal to approximately 15 mPa·s, and less than or equal to approximately 60 mPa·s, or less than or equal to approximately 50 mPa·s. When the viscosity of the radiation curable inkjet ink at 25° C. falls within the range described above, the shape of ink droplet during the jetting of the ink droplet can be maintained, to efficiently form a printed layer having a three-dimensional shape.

The viscosity of the radiation curable inkjet ink at 55° C. may be greater than or equal to approximately 1 mPa·s, or greater than or equal to approximately 3 mPa·s, and less than or equal to approximately 15 mPa·s, or less than or equal to approximately 10 mPa·s. When the viscosity of the radiation curable inkjet ink at 55° C. falls within the range described above, the ink flowability during injection of the ink droplet can be ensured, to enhance the printability of the radiation curable inkjet ink.

The printed layer of the decorative sheet can be formed using the radiation curable inkjet ink. In one embodiment, the decorative sheet has a printed layer containing the cured product of the radiation curable inkjet ink.

In one embodiment, a method of producing a decorative sheet includes preparing a substrate; forming a printed layer on the substrate by inkjet printing the radiation curable inkjet ink onto the substrate; and curing the printed layer by irradiating the printed layer with radiation.

As the substrate, a sheet or a film made of various materials such as synthetic resin, paper, metal, and cloth can be used.

As radiation, ultraviolet rays are generally used from the viewpoint that a radiation source can be easily combined with an inkjet printing device. As a ultraviolet ray source, a high-pressure mercury lamp, a metal halide lamp, a fusion lamp (Hbulb), and the like can be used. The illuminance of the ultraviolet ray source can be, for example, greater than or equal to approximately 10 mW/cm², greater than or equal to approximately 50 mW/cm², or greater than or equal to approximately 100 mW/cm², less than or equal to approximately 10000 mW/cm², less than or equal to approximately 5000 mW/cm², or less than or equal to approximately 3000 mW/cm². The irradiation dose is, for example, greater than or equal to approximately 1 mJ/cm², greater than or equal to approximately 10 mJ/cm², or greater than or equal to approximately 50 mJ/cm², less than or equal to approximately 100000 mJ/cm², less than or equal to approximately 50000 mJ/cm², or less than or equal to approximately 30000 mJ/cm². The radiation curable inkjet ink can be cured by irradiation with ultraviolet rays in the air, but the irradiation with ultraviolet rays may be performed in an inert gas atmosphere.

In one embodiment, the decorative sheet includes a base film layer as a substrate, a printed layer disposed on the base film layer, and a protective layer disposed on the printed layer and having a texture. The protective layer is formed using a radiation curable inkjet ink. In the present disclosure, “disposed on” includes not only directly disposed on, but also indirectly disposed on. For example, one or more other layers may be provided between the printed layer and the protective layer. The layers disposed on the base film layer may be partially disposed.

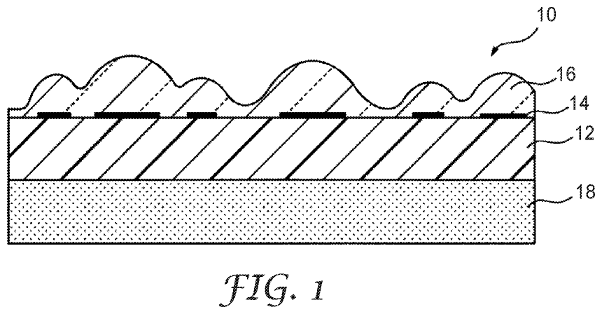

The decorative sheet of one embodiment is illustrated in a schematic sectional view in FIG. 1. A decorative sheet 10 includes a base film layer 12, a printed layer 14 disposed on the base film layer 12, and a protective layer 16 disposed on the printed layer 14. The protective layer 16 contains a cured product of a radiation curable inkjet ink which is printed by inkjet printing, and a texture is imparted to the decorative sheet by a three-dimensional shape of the protective layer 16. FIG. 1 shows that the printed layer 14 is completely covered with the protective layer 16, but a part of the printed layer 14 may be exposed to the outside. The printed layer 14 and the protective layer 16 may be each continuous or discontinuous.

As a base film layer, a film containing a variety of resins such as a polymethyl methacrylate (PMMA)-containing acrylic resin, polyurethane (PU), polyvinyl chloride (PVC), polycarbonate (PC), polyolefin such as polyethylene (PE) or polypropylene (PP), polyester such as polyethylene terephthalate (PET) or polyethylene naphthalate, a fluororesin, a copolymer such as an ethylene-vinyl acetate copolymer (EVA), an ethylene-acrylic acid copolymer, an ethylene-ethyl acrylate copolymer, an ethylene-vinyl acetate copolymer, an acrylonitrile-butadiene rubber (NBR), or an acrylonitrile-butadiene-styrene copolymer (ABS), or a mixture thereof can be used.

From the viewpoint of strength, impact resistance, and the like, a film containing polyurethane, polyvinyl chloride, polyethylene terephthalate, an acrylonitrile-butadiene-styrene copolymer, or polycarbonate can be advantageously used as the base film layer. The base film layer can function as a receptor layer for a printing ink and/or as a protective layer for protecting a surface of an adherend against puncture, impact, and the like from the outside. When the base film layer functions as a receptor layer for a printing ink, the base film layer which is a polyvinyl chloride film or a polyurethane film is advantageous in terms of printability, solvent resistance (e.g., alcohol resistance), and the like. In terms of flame retardancy, flexibility, and the like, a polyvinyl chloride film can be advantageously used as the base film layer.

The base film layer may have a variety of thicknesses. From the viewpoint of strength and ease of handling of the decorative sheet, the thickness of the base film may be generally greater than or equal to approximately 10 μm, greater than or equal to approximately 20 μm, or greater than or equal to approximately 50 μm, and less than or equal to approximately 500 μm, less than or equal to approximately 200 μm, or less than or equal to approximately 100 μm. The thickness of the base film layer when the base film layer is not flat is the thickness of the thinnest portion of the base film layer. For example, the base film layer may be embossed. The depth of embossing may be generally less than the thickness of the base film layer, and may be greater than or equal to approximately 1 μm, greater than or equal to approximately 2 μm, or greater than or equal to approximately 5 μm, and less than or equal to approximately 50 μm, less than or equal to approximately 20 μm, or less than or equal to approximately 10 μm.

The base film layer may be transparent, semi-transparent, or opaque, and may be colorless or colored. In one embodiment, the base film layer is colored white. This embodiment is advantageous in terms of sharpness, color development, and the like of an image formed in a printed layer disposed directly or indirectly on the base film layer.

The printed layer is used to impart decorativeness or design properties to the decorative sheet with a design, a pattern, or the like. The printed layer can be formed by printing with a colorant such as a toner or an ink on the base film layer directly or through another layer. When the base film layer is transparent or semi-transparent, the printed layer can be also formed between the base film layer and an adhesive layer. The printed layer may be formed using a printing technique such as gravure printing, electrostatic printing, screen printing, inkjet printing, or offset printing. A solvent-based ink or an UV-curable ink can be used as a printing ink.

In an embodiment, the printed layer is an inkjet printed layer. In another embodiment, the printed layer is formed by inkjet printing with the UV-curable ink. Inkjet printing, particularly inkjet printing with the UV curable ink facilitate on-demand, quick-delivery production.

The thicknesses of the printed layer may vary, and when a solvent-based ink is used, the thickness may be typically greater than or equal to approximately 1 μm or greater than or equal to approximately 2 μm, and less than or equal to approximately 10 μm or less than or equal to approximately 5 μm. When a UV curable ink is used, the thickness may be greater than or equal to approximately 1 μm or greater than or equal to approximately 5 μm or greater, and less than or equal to approximately 50 μm or less than or equal to approximately 30 μm.

The printed layer may be continuous or discontinuous. The printed layer may be disposed so as to correspond to the entire surface of the decorative sheet, or may be disposed so as to correspond to a portion or a plurality of portions of the decorative sheet.

The protective layer containing the cured product of the radiation curable inkjet ink is disposed over the printed layer and has a texture formed by inkjet printing the radiation curable inkjet ink. In general, the texture of the protective layer is visually or tactilely sensed by an observer since the protective layer has a three-dimensional shape.

When inkjet printing with the radiation curable inkjet ink is performed on the base film layer directly or through another layer and the radiation curable inkjet ink is irradiated with radiation such as ultraviolet light or an electron beam, resulting in curing, the protective layer having a texture can be formed. Printing with the radiation curable inkjet ink may be performed on at least a portion of the printed layer or on the entire printed layer. Printing with the radiation curable inkjet ink may be repeatedly performed a plurality of times, locally or on the entire surface, to increase the thickness of the protective layer.

The protective layer may have a variety of thicknesses. In some embodiments, the thickness of the protective layer may be at least partially greater than or equal to approximately 7 μm, greater than or equal to approximately 20 μm, or greater than or equal to approximately 30 μm. When the protective layer has a portion having a thickness of greater than or equal to approximately 7 μm, a texture with the real feel of a material or three-dimensional convexities and concavities which correspond to the design of the decorative sheet can be imparted to a surface of the decorative sheet.

In some embodiments, the maximum thickness of the protective layer is less than or equal to approximately 500 μm, less than or equal to approximately 300 μm, or less than or equal to approximately 100 μm. When the maximum thickness of the protective layer is less than or equal to approximately 500 μm, the flexibility, for example, the elongation properties of the protective layer may be suitable.

In some embodiments, the maximum height roughness Rz of the protective layer is greater than or equal to approximately 0.5 μm, greater than or equal to approximately 1 μm, or greater than or equal to approximately 1.5 μm, and less than or equal to approximately 20 μm, less than or equal to approximately 15 μm, or less than or equal to approximately 10 μm. When the maximum height roughness Rz of the protective layer falls within the range described above, a texture with the real feel of a material or three-dimensional convexities and concavities which correspond to the design of the decorative sheet can be imparted to the surface of the decorative sheet.

The protective layer may be transparent or semi-transparent. The protective layer is preferably transparent. In some embodiments, the total light transmittance of the protective layer is greater than or equal to approximately 90%, greater than or equal to approximately 92%, or greater than or equal to approximately 95%, and the haze is less than or equal to approximately 2%, less than or equal to approximately 1.5%, or less than or equal to approximately 1.0%. When the total light transmittance and haze fall within the ranges described above, an image provided by the printed layer of the decorative sheet can have an increased sharpness. The haze is determined according to JIS K 7136:2000 (ISO 14782:1999).

The decorative sheet may further include an adhesive layer disposed on the base film layer on a side opposite to the printed layer. FIG. 1 illustrates an adhesive layer 18 disposed on the base film layer 12 on a side opposite to the printed layer 14. In general, the adhesive layer can be formed using a solvent-type, emulsion-type, pressure-sensitive-type, heat-sensitive-type, heat-curable, or ultraviolet-curable adhesive, including an acrylic, a polyolefin, a polyurethane, a polyester, a rubber, or the like.

The thickness of the adhesive layer may be typically greater than or equal to approximately 3 μm, greater than or equal to approximately 5 μm, or greater than or equal to approximately 10 μm, and less than or equal to approximately 100 μm, less than or equal to approximately 80 μm, or less than or equal to approximately 50 μm.

In one embodiment, the adhesive layer is a pressure-sensitive adhesive layer. In order to adjust the adhesion force of the pressure-sensitive adhesive layer, the pressure-sensitive adhesive layer may contain elastic microspheres including a polyester, a polystyrene, an acrylic resin, a polyurethane, or the like.

A liner may be disposed on a surface of the adhesive layer. Examples of the liner may include papers such as kraft paper, polymers such as a polyethylene, a polypropylene, a polyester, and cellulose acetate, and a paper coated with the polymer. The liner may have a surface that has been subjected to a release treatment using a silicone, a fluorocarbon, or the like. The thickness of the liner is generally greater than or equal to approximately 5 μm, greater than or equal to approximately 15 μm, or greater than or equal to approximately 25 μm, and less than or equal to approximately 300 μm, less than or equal to approximately 200 μm, or less than or equal to approximately 150 μm.

The adhesive layer may have a microstructured surface having a communication path extending to an outer edge of the adhesive layer. When the decorative sheet is applied to an adherend, air bubbles, which are present between the decorative sheet and the adherend, can be discharged to the outside through the communication path of the microstructured surface. In this embodiment, the liner may have a concavo-convex structure on a release face of the liner, where the concavo-convex structure corresponds to the microstructured surface of the adhesive layer. The liner may be the same as or different from one used in forming the microstructured surface of the adhesive layer.

Another layer, for example, a decorative layer such as a metal layer, a receptor layer of printing ink, or the like may be laminated on the base film layer. These layers may be bonded through a bonding layer. The decorative layer may be disposed so as to correspond to the entire surface of the decorative sheet, or may be disposed so as to correspond to a portion or a plurality of portions of the decorative sheet.

The metal layer can be formed by vapor deposition or sputtering of a metal such as indium, tin, or chromium onto the base film layer or the other layer of the decorative sheet. A metal mask or the like may be also used upon vapor deposition or sputtering, to form a pattern or design. The metal layer may have a variety of thicknesses. The thickness of the metal layer is generally greater than or equal to approximately 5 nm, greater than or equal to approximately 10 nm, or greater than or equal to approximately 20 nm, and less than or equal to approximately 10 μm, less than or equal to approximately 5 μm, or less than or equal to approximately 2 μm.

As the receptor layer of printing ink, various resin layers can be used. A resin constituting the receptor layer is not particularly limited. As the resin, an acrylic polymer, a polyolefin, polyvinyl acetal, a phenoxy resin, or the like can be used. The glass transition temperature of the resin forming the receptor layer can be generally higher than or equal to approximately 0° C. and lower than or equal to approximately 100° C. When the glass transition temperature falls within the range described above, an image provided by transcription of a toner or printing with an ink can have an increased sharpness without impairing the flexibility of the whole decorative sheet. The thickness of the receptor layer may be generally greater than or equal to approximately 2 μm, greater than or equal to approximately 5 μm, or greater than or equal to approximately 10 μm, and less than or equal to approximately 50 μm, less than or equal to approximately 40 μm, or less than or equal to approximately 30 μm.

In general, the bonding layer which bonds layers constituting the decorative sheet contains a solvent-type, emulsion-type, pressure-sensitive-type, heat-sensitive-type, heat-curable, or ultraviolet-curable adhesive, including an acrylic, a polyolefin, a polyurethane, a polyester, rubber, or the like. The thickness of the bonding layer may be generally greater than or equal to approximately 1 μm, greater than or equal to approximately 2 μm, or greater than or equal to approximately 5 μm, and less than or equal to approximately 50 μm, less than or equal to approximately 40 μm, or less than or equal to approximately 30 μm.

In one embodiment, the printed layer has a two-dimensional design pattern, the protective layer has a three-dimensionally shaped pattern, and the two-dimensional design pattern coincides with the three-dimensionally shaped pattern. Since the two-dimensional design pattern of the printed layer coincides with the three-dimensionally shaped pattern of the protective layer, a texture can be further enhanced from both the visual and tactile aspects.

A decorative sheet in which the two-dimensional design pattern of the printed layer coincides with the three-dimensionally shaped pattern of the protective layer can be produced by a method including: providing an image data of the printed layer; converting the image data of the printed layer to a gray scale, to produce a gray scale image data; inverting a tone of the gray scale image data to produce an image data of the protective layer; as necessary, adjusting a tone curve of the image data of the protective layer; forming a printed layer having the two-dimensional design pattern on the base film layer by inkjet printing with an UV curable CMYK ink based on the image data of the printed layer; and forming the protective layer on the printed layer by inkjet printing with the radiation curable inkjet ink based on the image data of the protective layer.

Forming the printed layer and forming the protective layer may be successively performed. Forming the printed layer and forming the protective layer may be performed in one device provided with a plurality of inkjet printing heads. In order to form a protective layer including convexities and concavities having a large difference in height on a surface by repeating forming the protective layer, an inkjet printing device may be provided with a conveying unit capable of reciprocating a printed matter (e.g., a film of the base film layer), or a plurality of inkjet printing heads of the protective layer.

The two-dimensional design pattern of the printed layer can be coincide with the three-dimensionally shaped pattern of the protective layer more precisely by arranging an inkjet printing head for the printed layer and an inkjet printing head for the protective layer in series in the inkjet printing device, and successively forming the printed layer and the protective layer by printing based on the image data of the printed layer and the image data of the protective layer, respectively, which are obtained by the method described above.

The two-dimensional design pattern of the printed layer and the three-dimensionally shaped pattern of the protective layer may be repeated in one decorative sheet or may be a non-repetitive pattern. Inkjet printing can easily form not only the repetitive pattern but also the non-repetitive pattern. In embossing finishing using an embossing roller, a three-dimensionally shaped pattern, with a size longer than the outer circumference of the embossing roller and without repetition, cannot be formed. The use of the non-repetitive pattern can increase the degree of freedom in terms of design, and a decorative sheet having a design of an article can be produced.

In one embodiment, the decorative sheet has an elongation at break of greater than or equal to approximately 50%, greater than or equal to approximately 60%, or greater than or equal to approximately 70% at 20° C. The elongation at break can be determined as follows: The decorative sheet is cut into a length of 102 mm and a width of 25.4 mm, and a tensile test is performed using a tensile tester, with a grip distance of 50 mm, a tensile speed of 300 mm/minute, and at 20° C. The elongation at break can be determined from Equation: [(length of decorative sheet at break)−(length of decorative sheet before elongation)]/(length of decorative sheet before elongation)×100(%).

The total thickness of the decorative sheet is generally greater than or equal to approximately 50 μm, greater than or equal to approximately 60 μm, or greater than or equal to approximately 70 μm, and less than or equal to approximately 700 μm, less than or equal to approximately 600 μm, or less than or equal to approximately 500 μm. The total thickness of the decorative sheet does not include a thickness of the liner.

In one embodiment, an impact resistance (low-temperature impact resistance) of the decorative sheet at 5° C. is greater than or equal to 40 in·lbs (about 4.52 Nm). In this embodiment, the component and composition of the radiation curable inkjet ink used in formation of the protective layer is determined such that the decorative sheet has impact resistance described above. The thickness of the protective layer, the material and thickness of the base film layer, and the like may also contribute to the impact resistance of the decorative sheet. In consideration of these contribution, the component and composition of the radiation curable inkjet ink may be determined.

The impact resistance of the decorative sheet at 5° C. is preferably greater than or equal to approximately 50 in·lbs (approximately 5.65 Nm), and more preferably greater than or equal to approximately 60 in·lbs (approximately 6.78 Nm). In some embodiments, the impact resistance of the decorative sheet at 5° C. is less than or equal to approximately 200 in·lbs (approximately 22.6 Nm), less than or equal to approximately 150 in·lbs (approximately 17.0 Nm), or less than or equal to approximately 100 in·lbs (approximately 11.3 Nm). Impact resistance is determined as follows. The decorative sheet is cut into a length of 150 mm and a width of 70 mm, bonded to an aluminum plate having a length of 150 mm, a width of 70 mm, and a thickness of 1 mm at 25° C., and the decorative sheet is left at a temperature of 5° C. for 24 hours. Then, the specimen is set in an impact resistance test device. At a temperature of 5° C., a 2-pound weight is dropped onto a surface of the decorative sheet while the height is changed from 5 inches to 40 inches. The appearance of the decorative sheet is observed. The impact resistance is defined as a moment (in·lbs) when cracking occurs.

The decorative sheet can be provided in various forms such as a single sheet, a roll, and a laminate of a plurality of decorative sheets. In one embodiment, the decorative sheet has a roll shape.

The decorative sheet can be adhered to a surface of various adherends, and for example, can be applied to concrete, glass, a painting sheet, a flooring material, a wallpaper, a plasterboard, and the like. The adherend may be a part of a construction structure, such as a wall, a window, a floor, a ceiling, and a column.

### EXAMPLES

In the following examples, specific embodiments of the present disclosure will be exemplified, but the present invention is not limited thereto. All “parts” and “percent” are based on mass unless otherwise specified.

Materials and reagents used in the Examples are shown in Table 1.

TABLE 1

| Name or | | |
|---|---|---|
| abbreviation | Description | Supplier |
| CN991NS | Aliphatic polyester urethane | Sartomer |
| | acrylate oligomer, weight average | (Pennsylvania, USA) |
| | molecular weight 1290 | |
| TMCHA | 3,3,5-trimethylcyclohexyl | Osaka Organic Chemical |
| | acrylate | Industry Ltd. |
| | | (Osaka City, Osaka, Japan) |
| NOAA | n-octyl acrylate | Osaka Organic Chemical |
| | | Industry Ltd. |
| | | (Osaka City, Osaka, Japan) |
| TMPTA | Trimethylolpropane triacrylate | Osaka Organic Chemical |
| | | Industry Ltd. |
| | | (Osaka City, Osaka, Japan) |
| Esacure | Oligo (2-hydroxy-2-methyl-1- | IGM Resins B.V. |
| (trade name) | [4-(1-methylvinyl)phenyl] | (Waalwijk, Netherlands) |
| ONE | propanone), number average | |
| | molecular weight 423 | |
| BP | Benzophenone | Shuang Bang |
| | | (Nantou City, Taiwan) |
| Esacure | Mixture of 2,4,6- | IGM Resins B.V. |
| (trade name) | trimethylbenzophenone and | (Waalwijk, Netherlands) |
| TZT | 4-methylbenzophenone | |
| SB-PI 711 | Methyl-o-benzoylbenzoate | Shuang Bang |
| | | (Nantou City, Taiwan) |
| SB-PI 712 | 4-methylbenzophenone | Shuang Bang |
| | | (Nantou City, Taiwan) |
| Omnipol | Diester of | IGM Resins B.V. |
| (trade name) | carboxymethoxybenzophenone | (Waalwijk, Netherlands) |
| BP | and polytetramethylene glycol | |
| | 250, molecular weight 730 | |
| Omnipol | Benzophenone derivative | IGM Resins B.V. |
| (trade name) | polymer, molecular weight 620 | (Waalwijk, Netherlands) |
| 2702 | | |
| Omnirad | 1-hydroxycyclohexyl phenyl | IGM Resins B.V. |
| (trade name) | ketone | (Waalwijk, Netherlands) |
| 184 | | |
| Chivacure | 2,4,6- | Solvay Japan Co., Ltd. |
| (trade name) | trimethylbenzoyldiphenylphosphine | (Minato-ku, Tokyo, Japan) |
| TPO | oxide | |
| Genorad | Polymerization inhibitor | Rahn AG |
| (trade name) | | (Zurich, Switzerland) |
| 22 | | |

### Preparation of Radiation Curable Inkjet Ink

Radiation curable inkjet inks of Examples 1 to 9 and Comparative Examples 1 to 9 were prepared by the following procedure. The monofunctional and polyfunctional monomer shown in Table 2 and the bifunctional urethane (meth)acrylate oligomer and polymerization inhibitor were stirred with a mixer for 20 minutes to form a premix solution. To the premix solution, a photoinitiator was then added, and the mixture was stirred for 30 minutes to prepare a radiation curable inkjet ink. Numerical values in Table 2 are a compounded amount (part by mass) of each component.

The viscosity of the radiation curable inkjet ink was measured using a rheometer (Discovery HR-2, TA Instruments Japan Co., Ltd., Shinagawa-ku, Tokyo, Japan) under conditions of a temperature of 55° C. and a shear rate of 5000 sec⁻¹. The viscosities of the radiation curable inkjet inks of Examples 1 to 9 were less than or equal to 15 mPa·s at 55° C., and inkjet printability was achieved.

### Production of Film Sample—Coating 1

A HK-31WF PET film (Higashiyama Film Co., Ltd., Nagoya, Aichi, Japan) was coated with each of the radiation curable inkjet inks of Examples 1 to 8 and Comparative Examples 1 to 9 using a #20 wire bar. The coating was irradiated with ultraviolet light using a fusion lamp (Hbulb) (UVA: 1000 mW/cm², irradiation dose: 600 mJ/cm²), resulting in curing. As a result, a film sample was obtained. The thickness of the cured ink layer was approximately 30 μm. Film samples were used for odor testing and TVOC (total volatile organic compounds) analysis.

### Production of Film Sample—Coating 2

A 3M (trade name) Scotchcal (trade name) graphic film IJ180Cv3-10XR (polyvinyl chloride film, 3M Japan Limited, Shinagawa-ku, Tokyo, Japan) was coated with each of the radiation curable inkjet inks of Examples 1 to 8 and Comparative Examples 1 to 9 as the protective layer using a wire bar #20. The protective layer was irradiated with ultraviolet light using a fusion lamp (Hbulb) (UVA: 1000 mW/cm², irradiation dose: 600 mJ/cm²), resulting in curing. As a result, a film sample was obtained. The thickness of the cured protective layer was approximately 30 μm. The film sample was used for an abrasion resistance test, an elongation test, a low-temperature impact resistance test, and a color difference measurement.

### Production of Film Sample—Inkjet Printing

A protective layer was printed using the radiation curable inkjet ink of Example 9 on a 3M (trade name) Scotchcal (trade name) graphic film IJ180Cv3-10 (polyvinyl chloride film, 3M Japan Limited, Shinagawa-ku, Tokyo, Japan) with a UV inkjet printer (print head: KM1024iLMHB, 720×720 dpi, KONICA MINOLTA, INC., Chiyoda-ku, Tokyo, Japan). The protective layer was irradiated with ultraviolet light using a metal halide lamp (UVA: 908 mW/cm², irradiation dose: 731 mJ/cm²), resulting in curing. As a result, a film sample was obtained. The thickness of the cured protective layer was approximately 45 μm. The film sample was used for odor test, an abrasion resistance test, an elongation test, a low-temperature impact resistance test, and a color difference measurement.

The odor, TVOC analysis, scratch resistance, elongation properties, low-temperature impact resistance, and color difference of the film samples were evaluated by the following procedures. The evaluation results are shown in Table 2.

### Evaluation Method

### 1. Odor Test

The prepared film sample was left under conditions of 25° C. for 24 hours. Thereafter, the odor level was evaluated according to the following criteria.

AA: No odor or very weak odor

A: Low odor

B: Strong odor

C: Very strong odor

### 2. Total Volatile Organic Compounds (TVOC) Analysis

A film sample was cut into small pieces of 5 mm×5 mm and measured at 25° C. for 10 minutes using TD-GC/MS.

### 3. Scratch Resistance Test

A film sample was cut into 1 inch (25.4 mm)×6 inches (152 mm) and adhered on a HK-31WF PET film having a size of 1 inch (25.4 mm)×8 inch (203 mm) to be set in Color Fastness Rubbing Tester (AB-301, Tester Sangyo Co., Ltd., Miyoshi-cho, Iruma-gun, Saitama, Japan). Cotton (Kanakin No. 3) was clipped to the surface of the friction element of the testing machine. The film sample was rubbed back and forth for 100 strokes with a friction element having a load of 500 g. The appearance of the protective layer after friction was observed visually. A portion where damage did not occur was evaluated to be “good,” and a portion where damage occurred was evaluated to be “poor.”

### 4. Elongation Test (Elongation at Break)

The film sample was cut into 1 inch (25.4 mm)×4 inches (102 mm), and the sample was tested with a tensile tester (Tensilon universal testing machine, model: RTC-1210A, A&D Company, Limited, Toshima-ku, Tokyo, Japan) with a grip distance of 50 mm, a tensile rate of 300 mm/minute, and 20° C., to determine the elongation at break of the film. The elongation at break was determined from Equation: [(length of film sample at break)−(length of film sample before elongation)]/(length of film sample before elongation)×100(%).

### 5. Low-Temperature Impact Resistance Test

The film sample was cut into a length of 150 mm and a width of 70 mm, and adhered to an aluminum plate having a length of 150 mm, a width of 70 mm, and a thickness of 1 mm at 25° C. After leaving the film sample at 5° C. for 24 hours, it was set in an impact resistance test apparatus (IM-IG-1120, The Paul N. Gardner Company, Pompano Beach, Fla., USA). A 2-lb weight was dropped on the film surface at a temperature of 5° C. as the height of the weight drop was changed from 5 inches to 40 inches. The appearance of the film sample was observed and the moment (in·lbs) was recorded when crack was observed.

### 6. Color Difference Measurement

The L*, a*, and b* values of the film samples were measured using a spectrocolorimeter (CM-3700d, Konica Minolta Japan, Inc., Minato-ku, Tokyo, Japan). The values of the area where the radiation curable inkjet ink was not printed were defined as L₁*, a₁*, and b₁*, and the values of the printed area were defined as L₂*, a₂*, and b₂*, and the color difference ΔE* was calculated by the following equation:

Color difference ΔE*=[(L₂*−L₁*)²+(a₂*−a₁*)²+(b₂*−b₁*)²]^{1/2}.

TABLE 2

| | Example | Example | Example | Example | Example | Example |
|---|---|---|---|---|---|---|
| | 1 | 2 | 3 | 4 | 5 | 6 |
| CN991NS | 25.00 | 25.00 | 25.00 | 25.00 | 25.00 | 25.00 |
| TMCHA | 58.75 | 58.75 | 58.75 | 58.75 | 58.75 | 58.75 |
| NOAA | 12.50 | 12.50 | 12.50 | 12.50 | 12.50 | 12.50 |
| TMPTA | 3.75 | 3.75 | 3.75 | 3.75 | 3.75 | 3.75 |
| Esacure (trade name) | 5.00 | 5.00 | 5.00 | 5.00 | 5.00 | 5.00 |
| ONE | | | | | | |
| BP | 5.00 | — | — | — | — | — |
| Esacure (trade name) | — | 5.00 | — | — | — | — |
| TZT | | | | | | |
| SB-PI 711 | — | — | 5.00 | — | — | — |
| SB-PI 712 | — | — | — | 5.00 | — | — |
| Omnipol (trade name) | — | — | — | — | 5.00 | — |
| BP | | | | | | |
| Omnipol (trade name) | — | — | — | — | — | 5.00 |
| 2702 | | | | | | |
| Omnirad (trade name) | — | — | — | — | — | — |
| 184 | | | | | | |
| Chivacure (trade name) | — | — | — | — | — | — |
| TPO | | | | | | |
| Genorad (trade name) | 0.63 | 0.63 | 0.63 | 0.63 | 0.63 | 0.63 |
| 22 | | | | | | |
| Total | 110.6 | 110.6 | 110.6 | 110.6 | 110.6 | 110.6 |
| Application method | Coating | | | | | |
| Viscosity (mPa · s, 55° C.) | 7.1 | 7.1 | 7.3 | 7.2 | 8.4 | 8.1 |
| Odor | A | A | AA | A | AA | AA |
| TVOC(μg/g) | 15.5 | 4.8 | 0.6 | 8.5 | n.a. | n.a. |
| Scratch resistance | Good | Good | Good | Good | Good | Good |
| Elongation at break (%) | 74 | 72 | 73 | 75 | 72 | 69 |
| low-temperature impact | 60 | 60 | 50 | 60 | 60 | 60 |
| resistance (in · lbs, 5° C.) | | | | | | |
| Color difference ΔE* | 1.0 | 1.2 | 2.3 | 1.1 | 1.7 | 2.3 |
| | Example | Example | Example | Comparative | Comparative | Comparative |
| | 7 | 8 | 9 | Example 1 | Example 2 | Example 3 |
| CN991NS | 20.00 | 40.00 | 25.00 | 25.00 | 25.00 | 25.00 |
| TMCHA | 63.75 | 43.75 | 58.75 | 58.75 | 58.75 | 58.75 |
| NOAA | 12.50 | 12.50 | 12.50 | 12.50 | 12.50 | 12.50 |
| TMPTA | 3.75 | 3.75 | 3.75 | 3.75 | 3.75 | 3.75 |
| Esacure (trade name) ONE | 5.00 | 5.00 | 5.00 | — | 6.25 | — |
| BP | — | — | 5.00 | — | — | — |
| Esacure (trade name) TZT | — | — | — | — | — | — |
| SB-PI 711 | 5.00 | 5.00 | — | — | — | — |
| SB-PI 712 | — | — | — | — | — | — |
| Omnipol (trade name) BP | — | — | — | — | — | — |
| Omnipol (trade name) | — | — | — | — | — | — |
| 2702 | | | | | | |
| Omnirad (trade name) 184 | — | — | — | 10.00 | — | — |
| Chivacure (trade name) | — | — | — | — | — | 6.25 |
| TPO | | | | | | |
| Genorad (trade name) 22 | 0.63 | 0.63 | 0.63 | 0.63 | 0.63 | 0.63 |
| Total | 110.6 | 110.6 | 110.6 | 110.63 | 106.88 | 106.88 |
| Application method | Coating | | IJ | Coating | | |
| | | | printing | | | |
| Viscosity (mPa · s, 55° C.) | 5.7 | 15.0 | 7.1 | 6.8 | 7.0 | 6.8 |
| Odor | AA | AA | A | C | A | AA |
| TVOC(μg/g) | n.a. | n.a. | n.a. | 66.7 | 1.3 | 2.3 |
| Scratch resistance | Good | Good | Good | Poor | Poor | Poor |
| Elongation at break (%) | 72 | 75 | 76 | 80 | 78 | 82 |
| low-temperature impact | 40 | 80 | 50 | 60 | 60 | 70 |
| resistance (in · lbs, 5° C.) | | | | | | |
| Color difference ΔE* | 0.9 | 1.2 | 1.6 | 1.2 | 0.8 | 1.0 |
| | Compar- | Compar- | Compar- | Compar- | Compar- | Compar- |
| | ative | ative | ative | ative | ative | ative |
| | Example 4 | Example 5 | Example 6 | Example 7 | Example 8 | Example 9 |
| CN991NS | 25.00 | 25.00 | 0.00 | 10.00 | 15.00 | 50.00 |
| TMCHA | 58.75 | 58.75 | 83.75 | 73.75 | 68.75 | 33.75 |
| NOAA | 12.50 | 12.50 | 12.50 | 12.50 | 12.50 | 12.50 |
| TMPTA | 3.75 | 3.75 | 3.75 | 3.75 | 3.75 | 3.75 |
| Esacure (trade name) ONE | — | 5.00 | 5.00 | 5.00 | 5.00 | 5.00 |
| BP | 5.00 | — | — | — | — | — |
| Esacure (trade name) TZT | — | — | — | — | — | — |
| SB-PI 711 | — | — | 5.00 | 5.00 | 5.00 | 5.00 |
| SB-PI 712 | — | — | — | — | — | — |
| Omnipol (trade name) BP | — | — | — | — | — | — |
| Omnipol (trade name) 2702 | — | — | — | — | — | — |
| Omnirad (trade name) 184 | 5.00 | — | — | — | — | — |
| Chivacure (trade name) | — | 5.00 | — | — | — | — |
| TPO | | | | | | |
| Genorad (trade name) 22 | 0.63 | 0.63 | 0.63 | 0.63 | 0.63 | 0.63 |
| Total | 110.63 | 110.63 | 110.63 | 110.63 | 110.63 | 110.63 |
| Application method | Coating | | | | | |
| Viscosity (mPa · s, 55° C.) | 6.9 | 6.8 | 2.3 | 3.4 | 4.2 | 27.0 |
| Odor | B | A | AA | AA | AA | AA |
| TVOC(μg/g) | 62 | n.a. | n.a. | n.a. | n.a. | n.a. |
| Scratch resistance | Good | Poor | Poor | Poor | Poor | Good |
| Elongation at break (%) | 75 | 81 | 114 | 97 | 78 | 76 |
| low-temperature impact | 60 | 60 | 10 | 10 | 20 | 80 |
| resistance (in · lbs, 5° C.) | | | | | | |
| Color difference ΔE* | 1.0 | 2.5 | 2.2 | 2.3 | 2.3 | 2.4 |

1. A radiation curable inkjet ink comprising:
from 20 to 40 parts by mass of a bifunctional urethane (meth)acrylate oligomer and from 50 to 80 parts by mass of a monofunctional monomer, based on 100 parts by mass of polymerizable components; and
an α-hydroxyketone oligomer and a benzophenone compound as photoinitiators.

2. The radiation curable inkjet ink according to claim 1, wherein its viscosity at 55° C. is less than or equal to 15 mPa·s.

3. The radiation curable inkjet ink according to claim 1, wherein the monofunctional monomer is at least one type selected from the group consisting of linear or branched alkyl (meth)acrylates, alicyclic (meth)acrylates, and (meth)acrylates having a dioxane moiety or a dioxolane moiety.

4. The radiation curable inkjet ink according to claim 1, wherein the number average molecular weight of the α-hydroxyketone oligomer is from 350 to 1000.

5. The radiation curable inkjet ink according to claim 1, wherein the α-hydroxyketone oligomer has a 2-hydroxy-2-methyl-1-oxopropyl group.

6. The radiation curable inkjet ink according to claim 1, wherein the molecular weight of the benzophenone compound is from 182 g/mol to 1000 g/mol.

7. The radiation curable inkjet ink according to claim 1, wherein the weight average molecular weight of the bifunctional urethane (meth)acrylate oligomer is from 500 to 5000.

8. The radiation curable inkjet ink according to claim 1, further comprising a polyfunctional (meth)acrylate monomer.

9. A decorative sheet having a printed layer comprising a cured product of the radiation curable inkjet ink described in claim 1.

10. A method of producing a decorative sheet, the method comprising:
preparing a substrate;
forming a printed layer on the substrate by inkjet printing the radiation curable inkjet ink described in claim 1 onto the substrate; and
curing the printed layer by irradiating the printed layer with radiation.
